(19) United States
(12) Patent Application Publication
(10) Pub. No.: US 2018/0033175 A1
(43) Pub. Date: Feb. 1, 2018

(54) IMAGE DISPLAY DEVICE AND IMAGE DISPLAY SYSTEM

(71) Applicant: Sharp Kabushiki Kaisha, Osaka (JP)

(72) Inventors: Satoshi TERADA, Sakai City (JP); Hiroki MUNETOMO, Sakai City (JP)

(21) Appl. No.: 15/661,159

(22) Filed: Jul. 27, 2017

(30) Foreign Application Priority Data
Jul. 28, 2016 (JP) 2016-148786
Jul. 14, 2017 (JP) 2017-137881

(51) Int. Cl. G06T 11/60; G06F 3/0488; G06F 3/14

(52) U.S. Cl. CPC G06T 11/60; G06F 3/1454; G06F 3/04883

(57) ABSTRACT

An image display device, capable of communicating with another image display device capable of displaying an image in which figures including characters are placed, includes a figure input unit through which figures are inputted, an image display unit that displays an image in which the one or more inputted figures are placed, an area specification unit through which a partial area in the displayed image is specified, a figure acquisition unit that acquires figures contained in the specified area, a figure transmission unit that transmits the acquired figures and an attribute of the figures which is used when the another image display device displays the figures, for display on the another image display device.

### BACKGROUND

### 1. Field

The present disclosure relates to an image display device and the like.

### 2. Description of the Related Art

In recent years, image display devices provided with large-sized displays have been becoming widespread and meetings and classes with use of such image display devices like electronic white boards have been increasing accordingly. On the other hand, small and medium-sized portable terminals to be possessed by individuals also have been becoming widespread. Accordingly, attempts in which such portable terminals are linked with a shared and large-sized image display device installed in a conference room or a classroom have been being made in order to smooth information sharing or exchange of views among users and in order to improve convenience in meetings or classes.

Under these circumstances, embodiments have been disclosed in which each user transmits a memorandum from a tablet-like terminal device the user uses to the image display device described above (see Japanese Unexamined Patent Application Publication No. 2010-205137, for instance).

In late years, such terminal devices on user side also have been increasing in size. Accordingly, there are demands that a plurality of memoranda be written and be displayed on the image display device as appropriate. Conventionally, however, memoranda to be transmitted may merely be written and it has been impracticable to transmit selections from a plurality of figures, memoranda, and/or the like inputted into a terminal device.

Further, above-mentioned Japanese Unexamined Patent Application Publication No. 2010-205137 has problems in that pasting a plurality of memoranda on the image display device causes difficulty in reading due to display of the plurality of memoranda having similar shapes, difficulty in reading due to mixture of memoranda of higher importance and memoranda of lower importance, discriminability among writers of the memoranda, because it is impracticable to designate attributes (such as colors, sizes, shapes, importance, and owners) of the pasted memoranda. The problems may interfere with smooth exchange of views and information sharing.

Considering increase in size of image display devices, additionally, a method of use has been proposed in which an image display device is used as a table where input may be carried out on the spot, for instance. Such a method has caused a problem in that providing attributes for a handwritten memorandum involves selection from a menu or icons each time and thus has caused insufficient usability.

In order to settle the problems described above, it is desirable to provide an image display device and the like in which a figure is selected from one or more figures displayed, in which an attribute of the selected figure is determined, and which is capable of appropriately displaying the figure based on the attribute.

### SUMMARY

In order to settle the problems described above, an image display device of the disclosure includes a figure input unit through which figures including characters are inputted, an image display unit that displays an image in which the one or more inputted figures are placed, an area specification unit through which a partial area in the displayed image is specified, a figure acquisition unit that acquires figures contained in the specified area, an attribute determination unit that determines an attribute of the acquired figures which is used when the figures are displayed, and a figure display unit that displays the acquired figures based on the determined attribute of the figures.

An image display device of the disclosure is capable of communicating with another image display device capable of displaying an image in which figures including characters are placed and includes a figure input unit through which figures are inputted, an image display unit that displays an image in which the one or more inputted figures are placed, an area specification unit through which a partial area in the displayed image is specified, a figure acquisition unit that acquires figures contained in the specified area, an attribute determination unit that determines an attribute of the acquired figures which is used when the another image display device displays the figures, and a figure transmission unit that transmits the acquired figures and the attribute of the figures for display on the another image display device.

A program of the disclosure causes a computer to implement a figure input function through which figures including characters are inputted, an image display function of displaying an image in which the one or more inputted figures are placed, an area specification function through which a partial area in the displayed image is specified, a figure acquisition function of acquiring figures contained in the specified area, an attribute determination function of determining an attribute of the acquired figures which is used when the figures are displayed, and a figure display function of displaying the acquired figures based on the determined attribute of the figures.

A program of the disclosure causes a computer, the computer capable of communicating with another image display device capable of displaying an image in which figures including characters are placed, to implement a figure input function through which figures are inputted, an image display function of displaying an image in which the one or more inputted figures are placed, an area specification function through which a partial area in the displayed image is specified, a figure acquisition function of acquiring figures contained in the specified area, an attribute determination function of determining an attribute of the acquired figures which is used when the another image display device displays the figures, and a figure transmission function of transmitting the acquired figures and the attribute of the figures for display on the another image display device.

In an image display system of the disclosure including a first image display device and a second image display device that are each capable of displaying an image in which figures including characters are placed, the first image display device includes a figure input unit through which figures are inputted, an image display unit that displays an image in which the one or more inputted figures are placed, an area selection unit through which a partial area in the displayed image is selected, a figure specification unit that acquires and specifies figures contained in the selected area, an attribute determination unit that determines an attribute of the acquired figures which is used when the second image display device displays the figures, and a figure transmission unit that transmits the specified figures and the attribute of the figures to the second image display device, and the second image display device displays the figures received from the first image display device.

### BRIEF DESCRIPTION OF THE DRAWINGS

FIG. 1 is a diagram illustrating a whole system of a first embodiment;

FIG. 2 is a diagram illustrating configurations of functions of a terminal device in the first embodiment;

FIG. 3 is a diagram illustrating configurations of functions of a display device in the first embodiment;

FIGS. 4A to 4D are diagrams illustrating a summary of processing in the first embodiment;

FIG. 5 is a sequence diagram illustrating flow of processing in the terminal device and the display device in the first embodiment;

FIGS. 6A and 6B are diagrams illustrating an example of an operation in the first embodiment;

FIG. 7 is a diagram illustrating a configuration of a storage unit of the terminal device in a second embodiment;

FIGS. 8A to 8C each illustrate an example of data structure of a label data attribute determination table in embodiments;

FIG. 9 is a sequence diagram illustrating flow of processing in the terminal device and the display device in the second embodiment;

FIGS. 10A and 10B are diagrams illustrating an example of an operation in the second embodiment;

FIG. 11 is a diagram illustrating an example of an operation in a fourth embodiment;

FIG. 12 is a sequence diagram illustrating flow of processing in the terminal device and the display device in a fifth embodiment;

FIG. 13 is a diagram illustrating an example of an operation in a sixth embodiment;

FIG. 14 is a flow chart illustrating flow of processing in the terminal device in a seventh embodiment;

FIGS. 15A and 15B are diagrams illustrating an example of an operation in the seventh embodiment;

FIG. 16 is a flow chart illustrating flow of processing in the terminal device in an eighth embodiment;

FIGS. 17A and 17B are diagrams illustrating an example of an operation in the eighth embodiment;

FIGS. 18A and 18B are diagrams illustrating an example of an operation in a ninth embodiment;

FIGS. 19A and 19B are diagrams illustrating an example of an operation in a tenth embodiment;

FIGS. 20A and 20B are diagrams illustrating an example of an operation in a thirteenth embodiment;

FIG. 21 is a diagram illustrating an example of an operation in a fourteenth embodiment;

FIG. 22 is a diagram illustrating processing flow in a fifteenth embodiment;

FIGS. 23A and 23B are diagrams illustrating an example of an operation in the fifteenth embodiment;

FIGS. 24A and 24B are diagrams illustrating an example of an operation in the fifteenth embodiment;

FIG. 25 is a diagram illustrating processing flow in a sixteenth embodiment;

FIG. 26 is a diagram illustrating processing flow in the sixteenth embodiment; and

FIG. 27 is a diagram illustrating processing flow in a seventeenth embodiment.

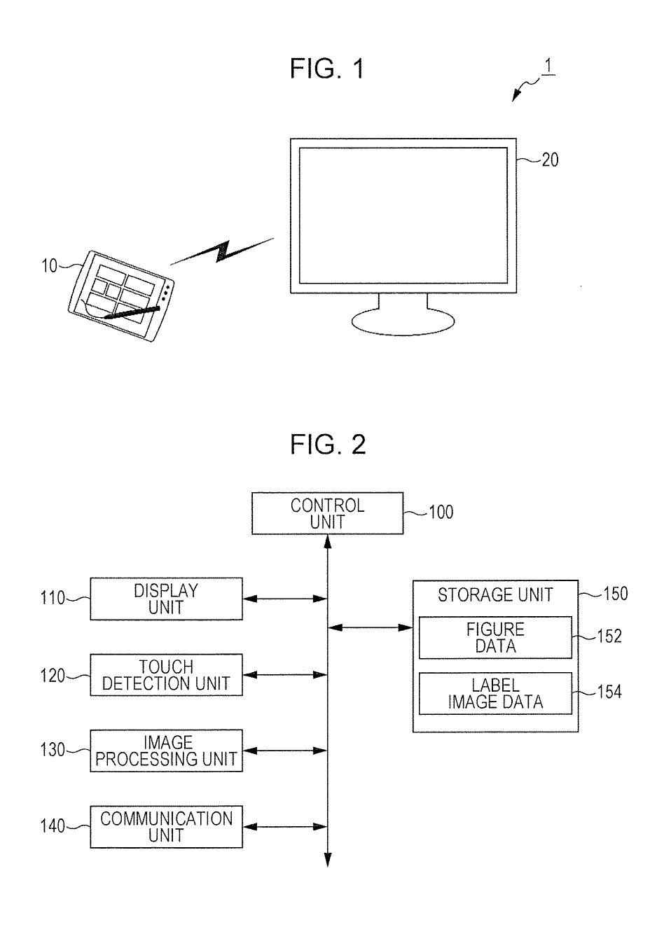

### DESCRIPTION OF THE EMBODIMENTS

Hereinbelow, an image display system 1 in which an image display device of the disclosure is used will be described. Embodiments will be presented below for convenience of description on the disclosure and the scope of the disclosure is not limited to the embodiments below.

### 1. First Embodiment

### [1.1 System Configuration]

Initially, a first embodiment will be described. The first embodiment, as the image display device, includes a terminal device 10 that is a portable display device such as a tablet and a stationary display device 20 such as a large-sized display.

The terminal device 10 and the display device 20 are configured so as to be connectable to each other. In the embodiment, for instance, the terminal device 10 and the display device 20 are connected so as to be communicable via LAN (wireless LAN or wired LAN). As another method of connection, near field communication such as Bluetooth® and ZigBee® or the like may be used for the connection. That is, the method of the connection does not matter as long as a scheme of the connection enables communication between the terminal device 10 and the display device 20.

### [1.2 Configurations of Functions]

Subsequently, configurations of functions will be described based on the drawings.

### [1.2.1 Terminal Device]

Initially, configurations of functions of the terminal device 10 will be described based on FIG. 2. The terminal device 10 includes a control unit 100, a display unit 110, a touch detection unit 120, an image processing unit 130, a communication unit 140, and a storage unit 150.

The control unit 100 is a functional unit that controls the whole of the terminal device 10. The control unit 100 implements various functions by reading out and executing various programs stored in the storage unit 150 and is made of a central processing unit (CPU) and the like, for instance.

The display unit 110 is a functional unit that displays various contents or the like. The display unit 110 is made of a liquid crystal display (LCD), an organic EL display, or the like, for instance. In the display unit 110, a full image is displayed all over a display area and figures are displayed in the full image.

The touch detection unit 120 is a functional unit that attains an operational input by detecting a touch operation of a user. The touch detection unit 120 is implemented with use of a touch panel or the like configured integrally with the display unit 110, for instance. As a method of detecting the touch operation, any of capacitive scheme, electromagnetic induction scheme, infrared scheme, and the like may be used as long as such detection can be carried out by the method. The detection may be carried out at one point or a plurality of points.

Figures are inputted through the touch detection unit 120. For instance, coordinates inputted through a touch by the user are detected and stroke information is stored based on the detected coordinates. Then a figure is recognized based on the stroke information and is stored as figure data 152. The figure is displayed in the full image without modification.

The image processing unit 130 is a functional unit that attains image processing. In the image processing unit 130, various types of image processing such as output of text characters through character recognition based on the inputted figures (handwritten characters) and clipping of an image of an enclosed area from the displayed full image are attained. Besides, processing such as conversion from the stroke information into a figure and conversion from vector data into raster data is carried out.

The image processing unit 130 may be implemented by being stored as programs in the storage unit 150 for each type of processing as appropriate and by being read out and executed as appropriate.

The communication unit 140 is a functional unit through which the terminal device 10 carries out communication. Wireless LAN such as IEEE802.11a/b/g/n or near field communication such as Bluetooth is used for the communication, for instance. Common communication, however, may be carried out therein by LTE communication or the like.

The storage unit 150 is a functional unit in which various programs and various data demanded for operations of the terminal device 10 are stored. The storage unit 150 is made of a semiconductor memory, a hard disk drive (HDD), or the like, for instance.

In addition to the various programs, the figure data 152 and label image data 154 are stored in the storage unit 150.

As the figure data 152, handwritten characters and handwritten figures based on stroke information stored by handwritten input (such as stroke drawing), images inputted from other input devices (such as scanner), and/or images received from other devices and stored are stored.

For instance, the stroke information inputted by handwriting by the user is gathered and thereby stored as a group of figures. In addition, image files such as JPEG data and BMP data from a scanner, a digital camera, image files, and/or the like are stored.

Herein, the term “figure” refers to a concept that encompasses characters and symbols. The characters (symbols) herein include handwritten characters that are characters written by the user with a touch pen, a hand, a mouse, or the like and text characters represented by ASCII, JIS code, Unicode, and the like.

Therefore, text characters (strings) inputted through input units such as keyboard, received text characters (strings), and/or the like are stored as the figure data 152. In this case, for instance, coordinates at which the display area is positioned and coordinates as text areas may be stored together with the text characters (strings).

The figures may each be composed of a character string that is a plurality of characters. In input by handwriting, in other words, strokes inputted in a first time interval are recognized as one handwritten character. Such handwritten characters inputted successively are recognized as a handwritten character string. Such characters and strings are stored as figures in the figure data 152.

Coordinates in the display area of the display unit 110 may be stored as each figure. The figures are each displayed in accordance with the coordinates and are thereby displayed as the full image on the display unit 110.

The label image data 154 is produced by clipping of a portion from the figures by the user. One or more clipped figures may be stored as the label image data or an image clipped from the full image may be stored as the label image data. In cases where the clipped figures are based on vector data or the stroke information, the figures may be clipped after conversion into raster data.

### [1.2.2 Display Device]

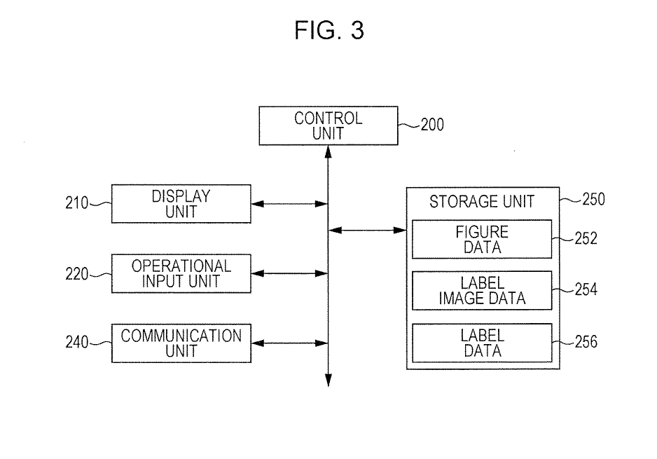

Subsequently, configurations of functions of the display device 20 will be described based on FIG. 3. As illustrated in FIG. 3, the display device 20 includes a control unit 200, a display unit 210, an operational input unit 220, a communication unit 240, and a storage unit 250.

The control unit 200 is a functional unit that controls the whole of the display device 20. The control unit 200 implements various functions by reading out and executing various programs stored in the storage unit 250 and is made of a central processing unit (CPU) and the like, for instance.

The display unit 210 is a functional unit that displays various contents or the like. The display unit 210 is made of a liquid crystal display (LCD), an organic EL display, or the like, for instance. On the display unit 210, a full image is displayed and figures are displayed in the full image.

The operational input unit 220 is a functional unit that attains an operational input from the user. The operational input unit 220 is implemented as an external keyboard, a mouse, a touch panel configured integrally with the display unit 210, or the like, for instance. As a method of detecting a touch operation, any of capacitive scheme, electromagnetic induction scheme, infrared scheme, and the like may be used as long as such detection can be carried out by the method. The detection may be carried out at one point or a plurality of points.

The communication unit 240 is a functional unit through which the display device 20 carries out communication. Wireless LAN such as IEEE802.11a/b/g/n or near field communication such as Bluetooth is used for the communication, for instance.

The storage unit 250 is a functional unit in which various programs and various data demanded for operations of the display device 20 are stored. The storage unit 250 is made of a semiconductor memory, a hard disk drive (HDD), or the like, for instance.

In addition to the various programs, figure data 252, label image data 254, and label data 256 are stored in the storage unit 250.

Figures inputted on the display device 20 and figures received from the terminal device 10 are stored as the figure data 252. The stored figure data is displayed on a display area of the display unit 210. The figure data 252 is stored as data of the same type as the figure data 152 and detailed description thereon is therefore omitted.

The label image data 254 is received from the terminal device 10. The label data 256 is generated and stored based on the label image data 254.

Herein, the label data described for the embodiment refers to data that makes it possible to manage the figures as a gathering. Not only may the label data be simply displayed, but the label data may be displayed with change in a color thereof and/or with movement thereof in the display area.

The label data may include the figures included in the label image data and/or text characters converted from handwritten characters. With regard to the label data, it may be made possible to freely perform switching between showing and hiding, pasting, deletion, and/or the like.

The label data may cumulatively be displayed on other displayed contents (such as figures or images) or may be displayed in isolation.

### [1.3 Flow of Processing]

Subsequently, flow of processing in the embodiment will be described based on the drawings.

### [1.3.1 Summary of Processing]

Initially, generation of the label data in the embodiment will be described. Though the generation in the terminal device 10 will be described herein, the generation may be carried out in the display device 20. The generation may be carried out with division of the processing between the terminal device 10 and the display device 20 as will be described later.

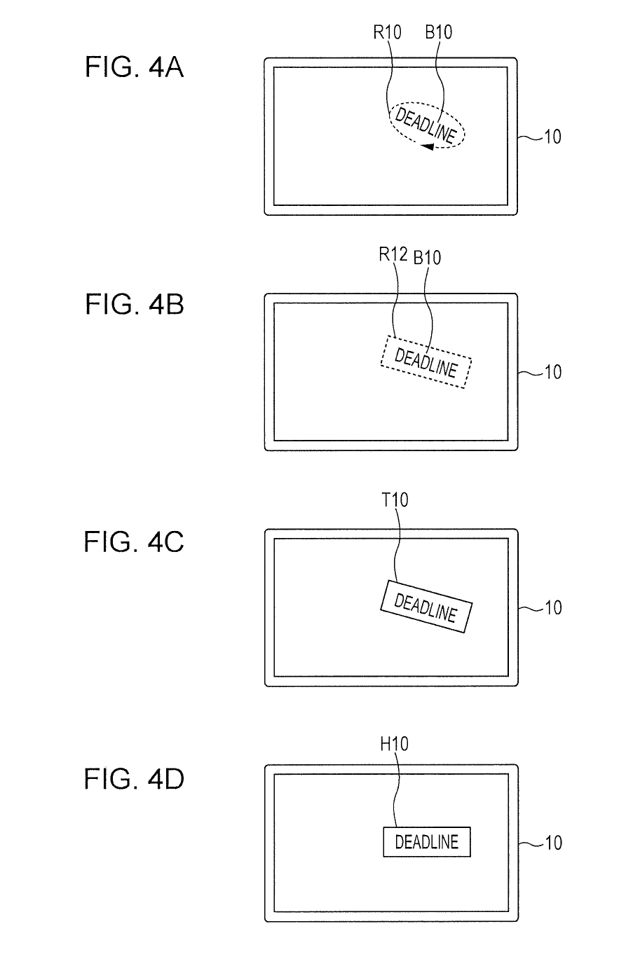

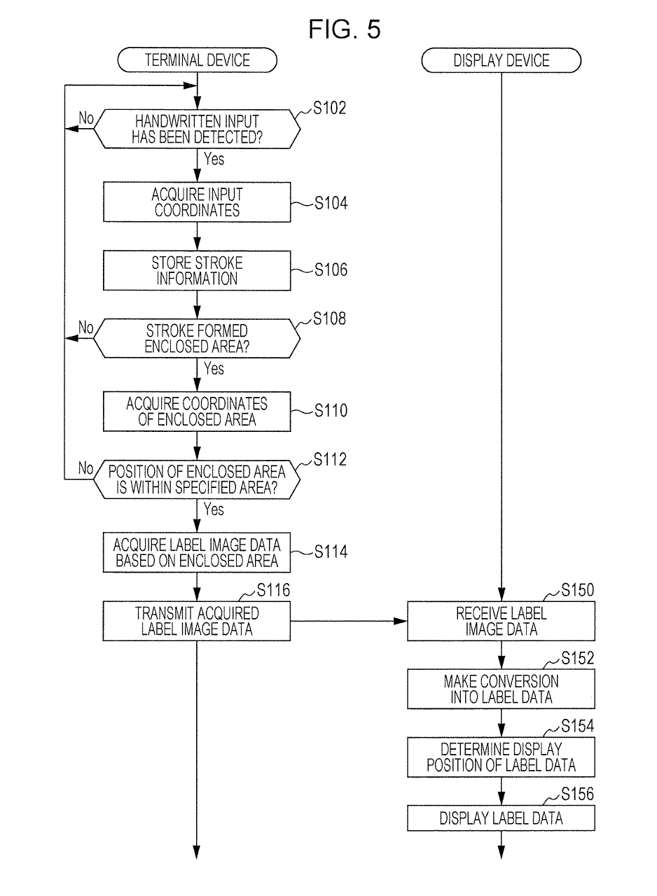

In FIG. 4A, a handwritten character string B10 “DEADLINE” is displayed as a figure. The handwritten character string B10 is displayed on the display area of the display unit 110.

The handwritten character string B10 is selected (specified) by the user so as to be enclosed. An area specified by being selected then will be referred to as an enclosed area R10. This stroke is formed so as to enclose the handwritten character string B10 and is therefore recognized as a label selection input.

When the label selection input is recognized, coordinates of the enclosed area are acquired so as to contain the handwritten character string B10. The coordinates of the enclosed area are coordinates of an area R12 in FIG. 4B. The handwritten character string B10 contained in the area R12 is recognized as label image data T10 (FIG. 4C).

Data recognized as the label image data T10 can be transmitted to other devices. FIG. 4D illustrates label data H10 converted from the label image data T10. In FIG. 4D, the handwritten character string “DEADLINE” has been converted into a text character string “DEADLINE” with conversion into the label data H10. The conversion into the text character string enables addition, editing, and the like of text characters therein. In the label data, attributes of a label (information associated with the label), such as color information, shape, owner, and size, are stored.

A plurality of figures may be selected by the enclosed area. Then the label data may be displayed for each figure or may collectively be displayed as one set of label data. When different types of figures (characters and images, for instance) are selected, the label data may be displayed for each figure or the label selection input may be cancelled.

### [1.3.2 Sequence Diagram]

Subsequently, the first embodiment will be described based on FIG. 5. FIG. 5 is a sequence diagram that illustrates processing on a transmitting side that transmits the label image data on which the label data is based and processing on a receiving side that receives the label image data. For the embodiment, description will be given with use of the terminal device 10 as an example of the transmitting side and with use of the display device 20 as an example of the receiving side.

When a handwritten input is detected in the terminal device 10 (step S102; Yes), input coordinates are acquired (step S104). The acquired coordinates are stored as stroke information (step S106).

If any enclosed area has not been formed (step S108; No), the stored stroke information is stored as a figure in the figure data 152. Any of related arts may be used as a method of storing a handwritten character (string), line segments, or the like, for instance, based on the stroke information.

If such a stroke has formed any enclosed area (step S108; Yes), it is determined that a label selection input has been provided and coordinates of the enclosed area are acquired (step S110).

As the coordinates of the enclosed area, for instance, coordinates that contain the enclosed area may be extracted. Then it may be determined whether a position of the enclosed area is a specified position or not (step S112). Specifically, positions where recognition as a label selection input is allowed may be preset in an input-acceptable area and formation of the enclosed area in the positions may be recognized as the label selection input, for instance.

When the processing is carried out in the whole display area, determination in step S112 may be omitted. That is, the processing may be made to proceed to step S114 subsequent to step S110.

Subsequently, the label image data is acquired based on the enclosed area (step S112; Yes→step S114). That is, figures contained in the enclosed area are acquired as the label image data. The acquired label image data is transmitted to the display device 20 that is the receiving side (step S116).

When the display device 20 that is the receiving side receives the label image data (step S150), the display device 20 makes a conversion into the label data based on the label image data (step S152). When a handwritten character (string) is included in the label data, specifically, processing for conversion into a text character (string) is carried out. The handwritten character (string) may be displayed without modification.

Subsequently, a display position of the label data is determined (step S154) and the label data is displayed (step S156).

A plurality of methods are conceivable for determining the display position of the label data. In an initially conceivable method, the position where the label data is to be displayed is predetermined as a default setting and the label data is displayed at the position of the default setting. Alternatively, the display position of the label data may be determined in accordance with the terminal device 10 that has transmitted the label image data. For instance, a screen may be quartered and an area for display thereon may be determined for each terminal.

### [1.4 Example of Operation]

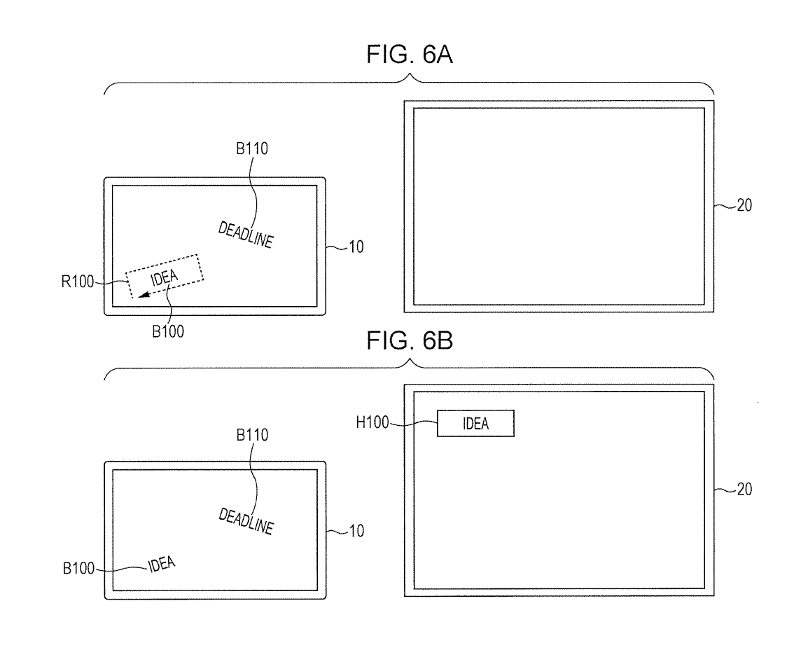

Subsequently, an example of an operation in the embodiment will be described with use of FIGS. 6A and 6B. In FIG. 6A, two figures are displayed on the display area of the terminal device 10. That is, a handwritten character string B100 “IDEA” and a handwritten character string B110 “DEADLINE” are displayed.

Then a rectangle R100 is inputted by the user. This input is provided as an enclosed area and is therefore recognized as a label selection input. The handwritten character string B100 contained in the rectangle R100 is acquired as label image data.

The label image data is transmitted from the terminal device 10 to the display device 20. In FIG. 6B, label data H100 is displayed on the display device 20 based on the label image data. As for the label data H100, the handwritten character string “IDEA” is converted into and displayed as a text character string “IDEA”.

The label data H100 can freely be moved and can be changed in size by the user. The conversion into the text characters as in the embodiment enables editing of the characters (string).

According to the embodiment, such an operation by the user of enclosing a desired figure makes it possible to transmit the figure inputted on one image display device as the label data to another image display device and to display the figure thereon.

This enables the user to carry out an input operation with utilization of a terminal device (an image display device such as a tablet, for instance) the user personally uses, for instance. Even if a plurality of users exist, furthermore, figures can be inputted and transmitted from each terminal device.

### 2. Second Embodiment

A second embodiment will be described. The second embodiment is processing in which an attribute of label data is also recognized in a label selection input based on a method of the selection input. That is, the attribute of the label data may be recognized in accordance with an attribute of an area (enclosed area) subjected to the selection input.

A configuration of a system in the embodiment is the same as that in the first embodiment described above and description on the configuration and the like is therefore omitted. Description on the embodiment will be centered on differences from the first embodiment.

### [2.1 Data Configuration]

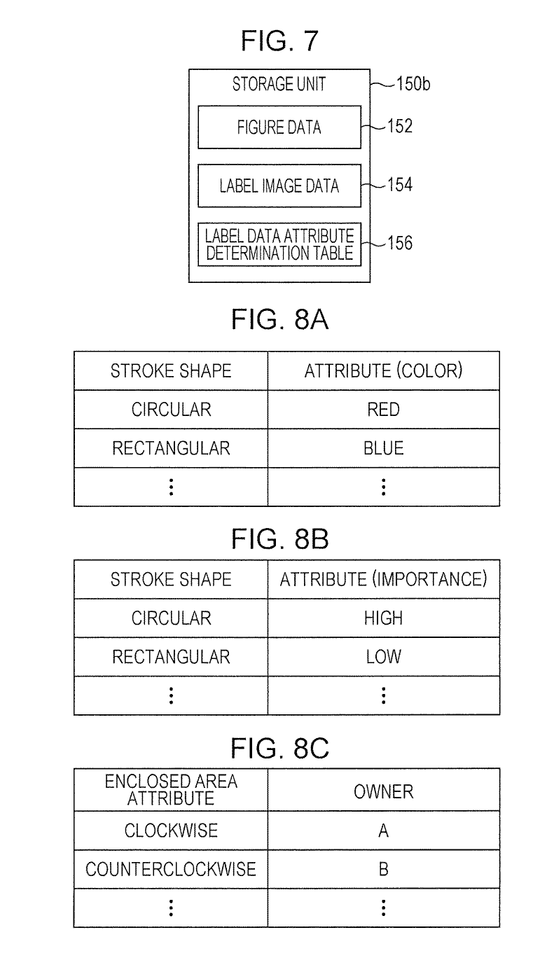

FIG. 7 illustrates the embodiment in which the storage unit 150 of the first embodiment is replaced by a storage unit 150b. As illustrated in FIG. 7, the figure data 152, the label image data 154, and a label data attribute determination table 156 are stored in the storage unit 150b.

The label data attribute determination table 156 is a table that stores an attribute of the label data in accordance with an attribute of the enclosed area inputted as the label selection input, that is, a stroke (shape) of the enclosed area in the embodiment. As illustrated in FIG. 8A, for instance, the attribute (“RED” as color, for instance) of the label data is stored in association with the stroke shape (“CIRCULAR”, for instance) that is the attribute of the area.

Though description on the embodiment is given with use of color as an example of the attribute of the label data, another display pattern such as size (font size), font type, and border color of the label data may be stored.

### [2.2 Flow of Processing]

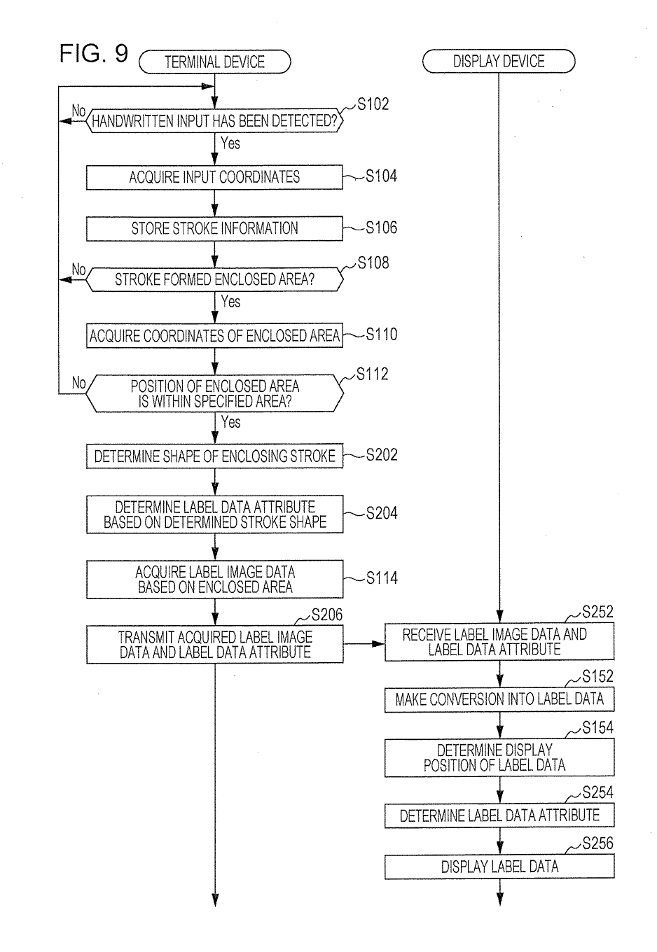

Flow of the processing of the embodiment will be described based on a sequence diagram of FIG. 9. The same processing as that of the first embodiment is provided with the same reference characters and description thereon is omitted.

If a detected stroke has formed any enclosed area and is determined as a label selection input (steps S102 to S112; Yes), a shape of the enclosing stroke is determined (step S202) and an attribute of the label data (label data attribute) is determined based on the determined shape of the stroke (step S204). Specifically, the label data attribute is determined based on the label data attribute determination table 156.

Subsequently, the label image data is acquired based on the enclosed area (step S114). After that, the acquired label image data and the label data attribute are transmitted to the display device 20 (step S206). Then label additional information including the label data attribute and other information (various types of information such as size of label, for instance) may be transmitted.

The flow of the processing in the embodiment is an example and may be permuted as long as any conflict is not caused in the data. For instance, the label image data may initially be acquired based on the enclosed area and the label data attribute may thereafter be determined (step S206→4 step S204).

The display device 20 receives the label image data and the label data attribute (step S252). After that, the label image data is converted into the label data and a display position of the label data is determined (step S152→4 step S154).

Then the attribute of the label data is determined based on the received label data attribute (step S254). Subsequently, the label data is displayed based on the determined attribute of the label data (step S256).

### [2.3 Example of Operation]

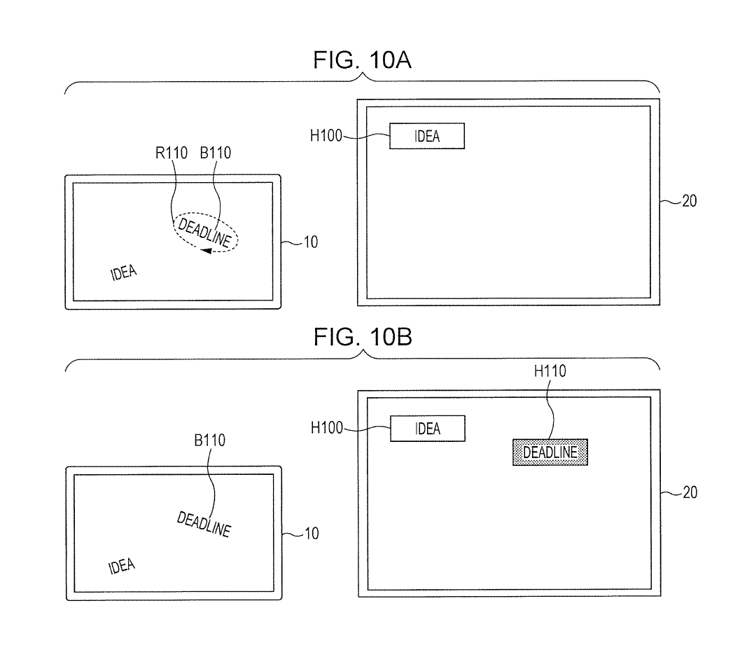

An example of an operation in the second embodiment will be described based on FIGS. 10A and 10B. FIG. 10A is a diagram in which the label data H100 based on the label image data transmitted from the terminal device 10 is displayed on the display device 20 in the first embodiment.

In this state, the handwritten character string B110 “DEADLINE” is selected by an enclosed area R110 specified by a stroke. In this case, label image data containing the handwritten character string B110 is acquired and is transmitted to the display device 20. Then an attribute of label data is additionally transmitted.

In FIG. 10B, the label data H110 converted from the received label image data is displayed on the display device 20. The attributes of the label data differ between a case where the shape of the stroke for the enclosed area is rectangular as in the label data H100 in the first embodiment and a case where the shape of the stroke for the enclosed area is circular as in the label data H110 in the embodiment. That is, the label data H100 and the label data H110 are displayed in different colors.

According to the embodiment, switching of the shape for selection of a figure by the user thus makes it possible to easily switch the attribute of the label data.

The user may arbitrarily set the shape of the stroke for the enclosed area that dictates the attribute of the label data and may arbitrarily set the attribute of the label data. Thus a desired attribute (such as color) can be assigned to a desired shape.

The label data attribute determination table 156 may be stored in the display device 20 so that the attribute of the label data may be determined in the display device 20. In this configuration, the label image data and the stroke information for the enclosed area are transmitted from the terminal device 10 to the display device 20. The attribute of the label data may be determined from the transmitted information in the display device 20.

### 3. Third Embodiment

A third embodiment will be described. Though a display attribute such as color is set as the attribute of the label data in the third embodiment, an attribute on contents may be set.

In the third embodiment, the label data attribute determination table 156 of FIG. 8A in the second embodiment is replaced by a label data attribute determination table of FIG. 8B.

That is, an attribute (“HIGH” as importance, for instance) may be stored in association with the stroke shape. In other words, an attribute on contents, such as importance, may be added as the attribute of the label data. The attribute may be such an attribute as “ERASABLE” and “NON-ERASABLE” or an attribute that represents the owner (Mr. A for the circular shape and Ms. B for the rectangular shape, for instance).

The label data may be displayed in accordance with the determined attribute of the label data (step S254→step S256 in FIG. 9). Thus the label data behaves in accordance with the label data attribute. For instance, in cases where the label data of “HIGH” importance is set “NON-ERASABLE”, the user is incapable of erasing the label data.

The display device 20 may modify a display format in accordance with those attributes. For instance, the data of high importance may be displayed in “red” or with “magnification”.

According to the embodiment, an attribute, other than that for mere display, of the label data thus can easily be added based on a drawing pattern.

### 4. Fourth Embodiment

A fourth embodiment will be described. In the fourth embodiment, an attribute set based on an attribute, other than the shape of the stroke, of the enclosed area is added to the label data.

In the fourth embodiment, the label data attribute determination table 156 of FIG. 8B in the third embodiment is replaced by a label data attribute determination table of FIG. 8C. That is, an attribute (owner “A” in the embodiment) of the label data is associated with an attribute, such as “CLOCKWISE” and “COUNTERCLOCKWISE”, of the enclosed area.

An attribute “A stroke made by two fingers for the enclosed area has been detected.” or an attribute “The enclosed area has been inputted with another type of operation.” may be set as another attribute of the enclosed area, for instance.

Another attribute such as size, color, and importance may be set as the attribute of the label data, as described above.

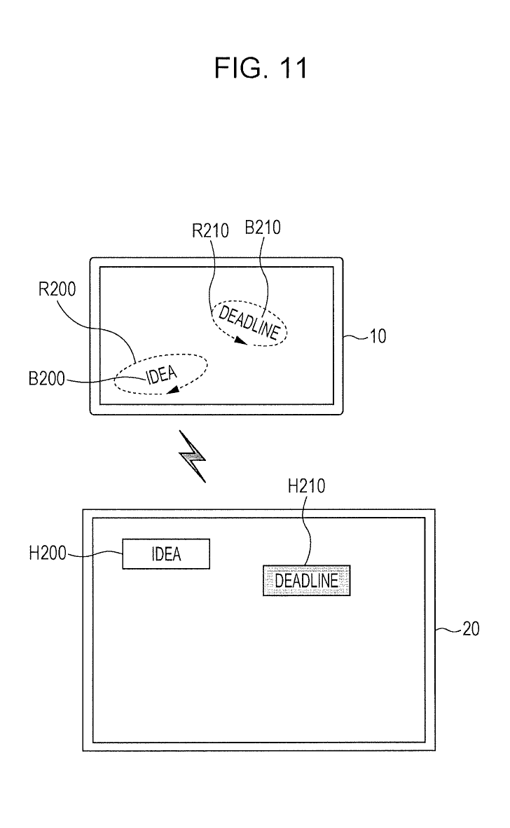

An example of an operation in the fourth embodiment is illustrated in FIG. 11, for instance. A handwritten character string B200 and a handwritten character string B210 are displayed on the terminal device 10. An enclosed area R200 is selected in a clockwise manner for the handwritten character string B200 and an enclosed area R210 is selected in a counterclockwise manner for the handwritten character string B210.

Therein, label data selected by the enclosed areas and converted is displayed on the display device 20. The label data H200 and the label data H210 having different attributes are displayed in different manners.

According to the embodiment, an attribute of label data thus can easily be changed in accordance with a manner of selecting an enclosed area in a label selection input.

### 5. Fifth Embodiment

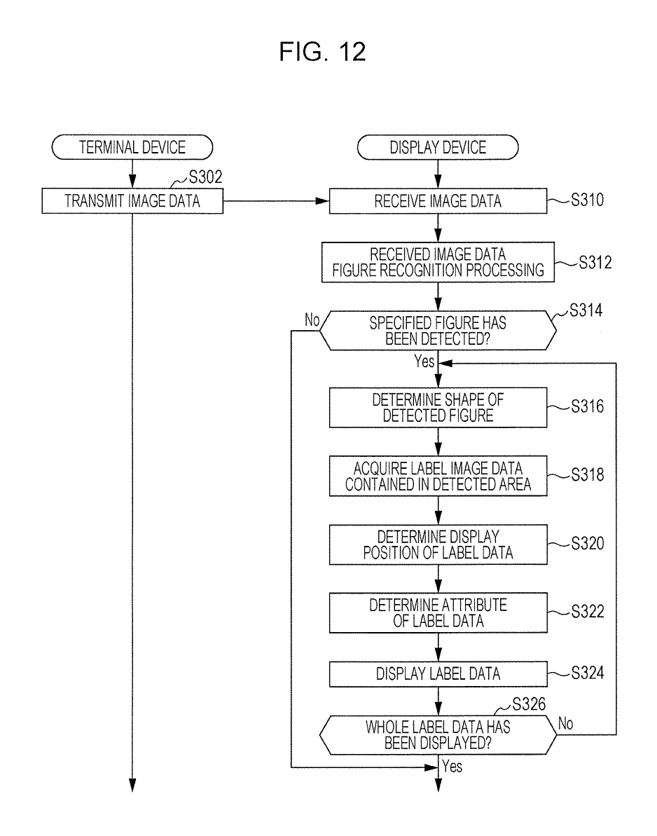

A fifth embodiment is an embodiment in which label data is recognized on a side of the display device 20. In the embodiment, a processing flow illustrated in FIG. 5 for the first embodiment is replaced by a processing flow of FIG. 12. The flow of processing in the embodiment will be described based on FIG. 12.

An image containing figures is displayed on the terminal device 10. Figures to be made into label data are selected from among the figures by an enclosed area and image data thereof is transmitted to the display device 20 (step S302).

When the display device 20 receives the image data (step S310), the display device 20 carries out figure recognition processing for the received image data (step S312) so as to acquire figures from the image.

Various methods are conceivable as a method of acquiring the figures from the image. In cases where the stroke information is transmitted together with the image data, the figures are recognized with reference to the stroke information. In cases where the image is vector data, the figures are recognized with reference to the vector data. In cases where the image is raster data, the figures are recognized based on shapes of the figures.

If specified figure data is detected in the recognized figures, a shape of the detected figure is determined (step S314; Yes→step S316). For instance, a shape of the enclosed area is detected or, when other figures are contained in the enclosed area, shapes of the figures are detected. It is then determined that the detected shape is a label selection input and figures contained in the detected area are acquired as label image data (step S318).

The label image data is converted into the label data and a display position of the label data is determined (step S320). Then an attribute of the label data is determined (step S322). The label data is displayed based on the converted label data and the display position and the attribute of the label data (step S324).

If the whole of the label data contained in the image has not been displayed, the processing is iteratively carried out (step S326; No→step S316). If the whole of the label data has been displayed, the processing is ended (step S326; Yes).

According to the embodiment, collective transmission of the image from the terminal device 10 thus makes it possible to display desired label data on the display device 20. Therefore, the label image data does not have to be transmitted iteratively and communication traffic between the terminal device 10 and the display device 20 can be reduced. Besides, an effect of collective processing is expected, providing that the display device 20 has higher processing capability than the terminal device 10 has.

### 6. Sixth Embodiment

Subsequently, a sixth embodiment will be described. In the sixth embodiment, in cases where label image data is acquired based on an enclosed area selected as a label selection input, figures belonging to the same figure group are acquired as the label image data even if any of the figures exist out of the enclosed area.

In the embodiment, the label image data is acquired based on the enclosed area in step S114 in the processing flow of FIG. 5 of the first embodiment. In the first embodiment, the figures contained in the enclosed area are acquired as the label image data.

In the embodiment, however, if a portion of a figure is contained in the enclosed area, the figure is acquired as the label image data.

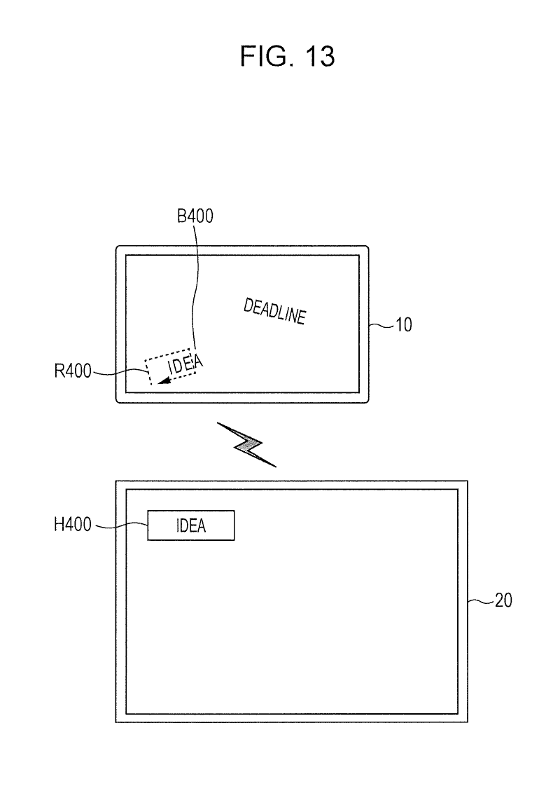

Description will be given with reference to FIG. 13. A handwritten character string B400 in FIG. 13 forms a figure as characters “IDEA”. That is, handwritten characters such as “I” are formed based on stroke information. Then the handwritten characters “D”, “E”, and “A” gather to form the handwritten character string “IDEA”.

In this state, a part “IDE” is contained in an enclosed area R400. The figure containing the part “IDE”, however, is the handwritten character string B400 “IDEA”. In this case, therefore, the figure “IDEA” is acquired as a figure contained in the enclosed area.

Then “IDEA” is displayed as label data H400 on the display screen of the display device 20. That is, the handwritten character string “IDEA” is converted into a text character string “IDEA”, which is displayed as the label data.

According to the embodiment, in cases where the user is to select a figure including a handwritten character string, the user has only to select an area containing the figure.

### 7. Seventh Embodiment

A seventh embodiment will be described. In the seventh embodiment, a selecting operation is carried out before transmission of label image data selected by an enclosed area.

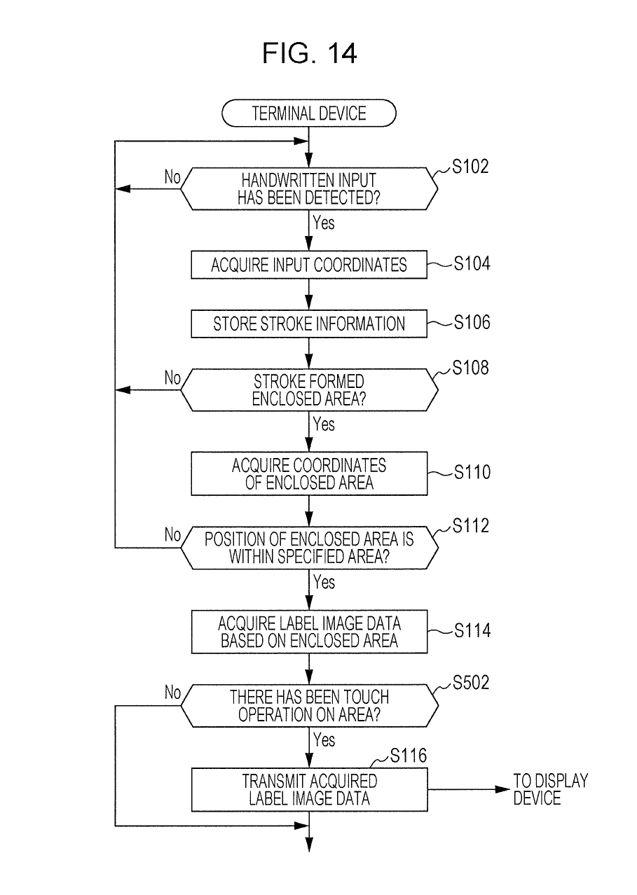

In the seventh embodiment, the processing in the terminal device 10 illustrated in FIG. 5 for the first embodiment is replaced by processing flow of FIG. 14. The same processing as that of FIG. 5 is provided with the same reference characters and description thereon is omitted.

Label image data is acquired based on an enclosed area (step S114) and it is thereafter determined whether there has been a touch operation on the enclosed area or not (step S502). If there has been the touch operation, the acquired label image data is transmitted to the display device 20 (step S116).

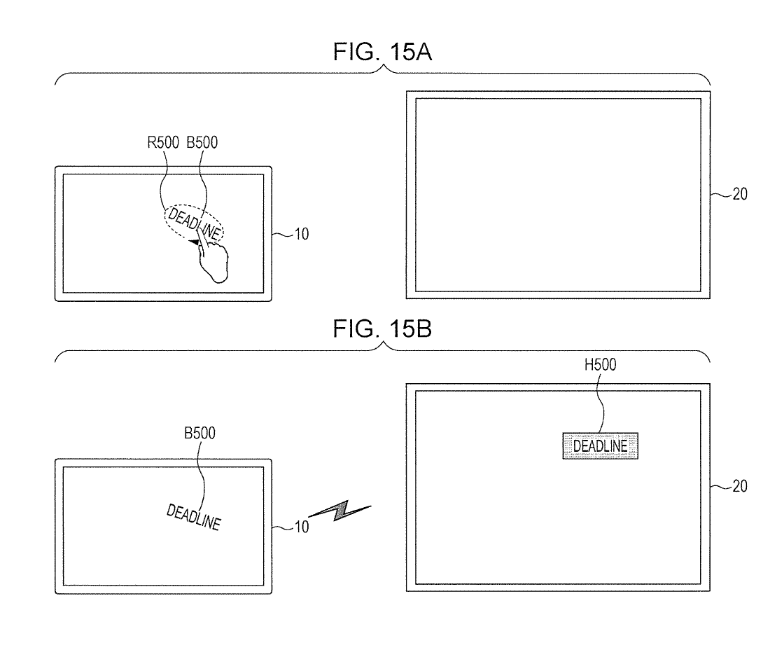

An example of an operation in the embodiment is illustrated in FIGS. 15A and 15B. In FIG. 15A, a handwritten character string B500 is selected by an enclosed area R500. When the user touches (makes a tapping operation on) inside of the enclosed area R500 at this point of time, label image data is transmitted to the display device 20. Label data H500 is thereby displayed as illustrated in FIG. 15B.

According to the embodiment, the user is thus capable of transmitting the label image data at any desired timing after the label image data is selected by the enclosed area. This makes it possible for the user to display a plurality of label data in a desired order, for instance.

Processing of step S502 is carried out posterior to step S114 as an example and may be carried out prior to step S114, for instance. That is, the label image data may be acquired after the touch operation is detected.

Specified timing may be determined as detection timing for step S502. For instance, the label image data may be cancelled (it is deemed that the label image data has not been selected) if the touch operation is not carried out in five seconds, for instance.

### 8. Eighth Embodiment

An eighth embodiment will be described. In the eighth embodiment, a cancelling operation for label image data selected by an enclosed area is carried out before transmission of the label image data.

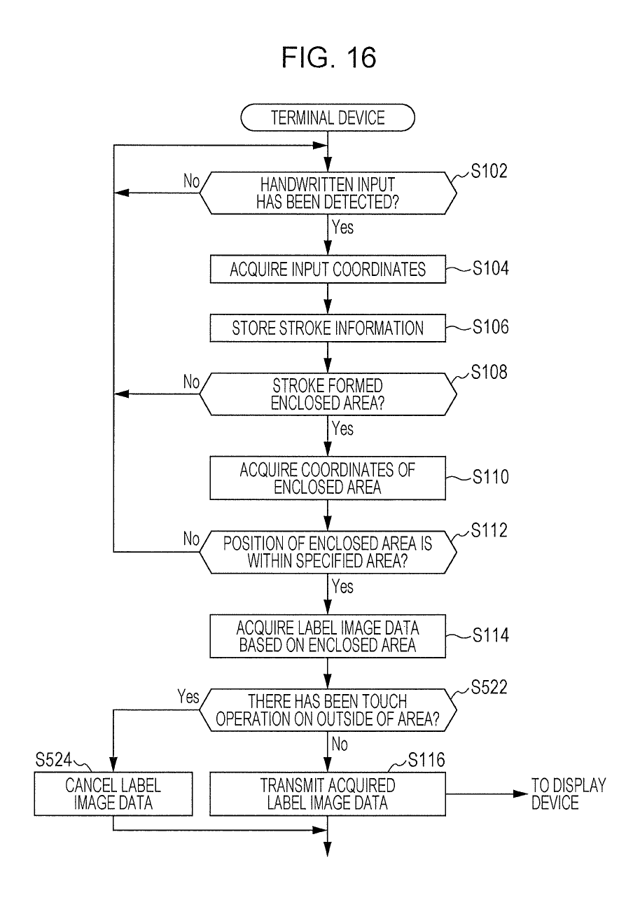

In the eighth embodiment, the processing flow in the terminal device 10 illustrated in FIG. 5 for the first embodiment is replaced by processing flow of FIG. 16. The same processing as that in FIG. 5 is provided with the same reference characters and description thereon is omitted.

The label image data is acquired based on an enclosed area (step S114) and it is thereafter determined whether there has been a touch operation on outside of the enclosed area or not (step S522). If there has been the touch operation on the outside, the acquired label image data is cancelled so as not to be transmitted to the display device 20 (step S524).

On the other hand, if any touch operation on the outside has not been detected, the acquired label image data is transmitted (step S522; No→step S116). Whether there has been any touch operation on the outside or not is determined based on whether there has been any touch in specified time or not. If the touch is not carried out in three seconds, for instance, a result of determination in step S522 is deemed No and the acquired label image data is transmitted to the display device 20.

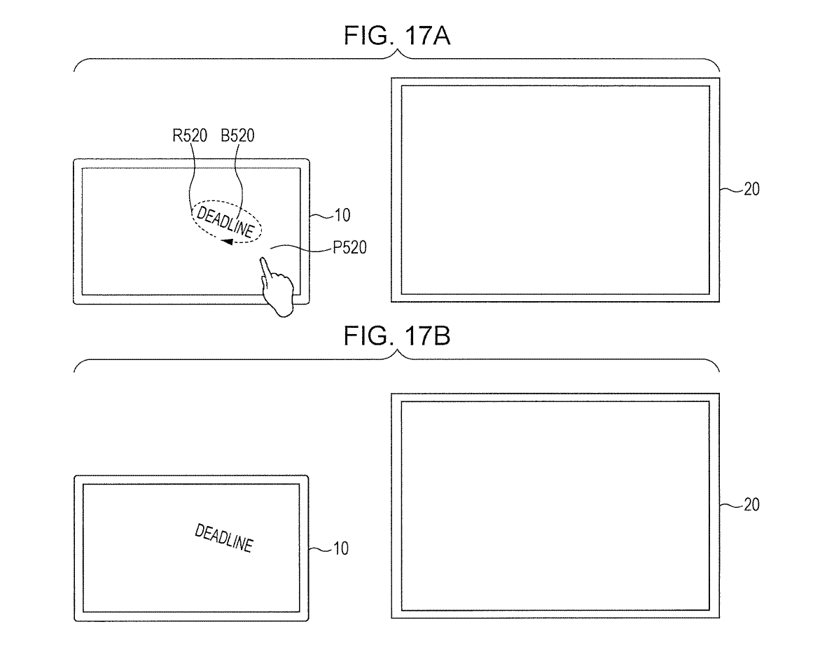

An example of an operation in the embodiment is illustrated in FIGS. 17A and 17B. In FIG. 17A, a handwritten character string B520 is selected by an enclosed area R520. When the user touches (makes a tapping operation on) outside P520 of the enclosed area R520 at this point of time, label image data selected by the enclosed area R520 is cancelled.

As illustrated in FIG. 17B, therefore, label data is not displayed on the display device 20 because of such cancellation.

According to the embodiment, the user is thus capable of cancelling the label image data after the label image data is selected by the enclosed area. Even if an unwanted figure is selected, for instance, the figure can be cancelled in this manner so as not to be displayed on the display device.

### 9. Ninth Embodiment

A ninth embodiment will be described. In the ninth embodiment, stroke information is switched into an ordinary figure input instead of a label selection input.

Though the embodiment combined with any of the embodiments described above can be described, a combination with the eighth embodiment will be described as an example.

That is, when the processing of cancelling the label image data is carried out in step S524 of FIG. 16 in the eighth embodiment, a diagram may actually be drawn on the terminal device 10 based on the stroke information.

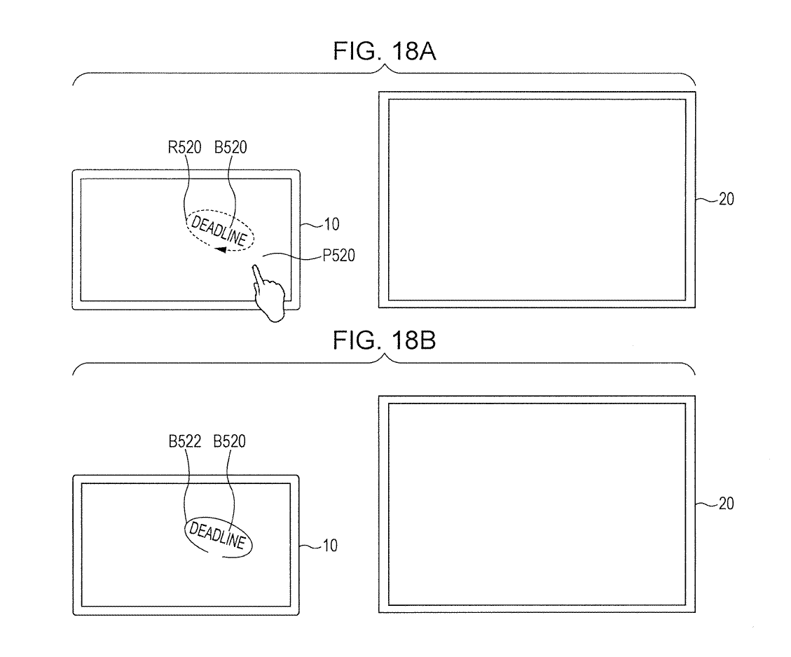

An example of an operation in this case is illustrated in FIGS. 18A and 18B. In FIG. 18A, which is similar to FIG. 17A for the eighth embodiment, surroundings of the handwritten character string B520 are selected by the enclosed area R520. The outside P520 of the enclosed area R520 is touched by the user.

As illustrated in FIG. 18B, the enclosed area R520 is then displayed as a figure B522 that is a diagram without modification. That is, the stroke information for the label selection input is used as stroke information for figure drawing without modification.

According to the embodiment, the user is thus capable of providing input with switching between the label selection input and figure drawing input. The switching may be combined with another embodiment. For instance, the switching may be carried out in accordance with the shape of the enclosed area or in accordance with the attribute of the enclosed area. The seventh embodiment may be configured so that the figure drawing input may be provided (that is, the label image data is not transmitted) if the inside of the enclosed area is touched and so that the label image data may be transmitted if the inside undergoes nothing.

### 10. Tenth Embodiment

A tenth embodiment will be described. In the tenth embodiment, a figure is selected by an enclosed area and a menu is thereafter displayed so that an operation may be carried out.

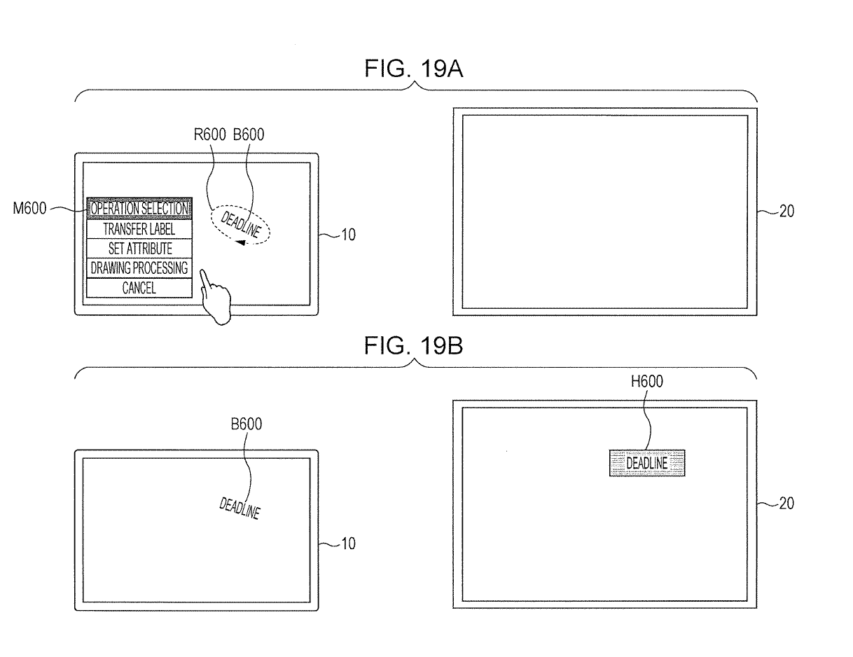

An example of an operation in the embodiment will be described with reference to FIGS. 19A and 19B. In FIG. 19A, a handwritten character string B600 is selected by an enclosed area R600. Then a menu display M600 is presented on a display screen of the terminal device 10.

The user selects a subsequent operation from a menu displayed on the menu display M600 and a behavior toward label image data is thereby determined. When “TRANSFER LABEL” is selected, for instance, label data H600 is displayed as illustrated in FIG. 19B.

An attribute of the label data may be set by being selected from the menu. In addition, various behaviors such as drawing processing and image transfer may be selectable.

According to the embodiment, use of the menu display thus makes it possible for the user to select a plurality of behaviors toward the label image data.

### 11. Eleventh Embodiment

An eleventh embodiment will be described. The eleventh embodiment in which recognition as label image data is made if any figure is contained in an enclosed area will be described.

In the embodiments described above, the figures contained in the enclosed area are acquired and made into the label image data. In FIG. 5 for the first embodiment, for instance, the label image data is acquired based on the enclosed area in step S114.

The embodiment may be configured so that label image data may not be acquired if figure data is not contained in the enclosed area.

In step S114, specifically, figure data contained in the enclosed area is acquired based on the enclosed area. In this configuration, the label selection input may be cancelled if figure data is not contained in the enclosed area. That is, the label image data is neither acquired and nor transmitted to the display device 20.

Line segments may be drawn based on stroke information inputted as the enclosed area, if the label image data is not acquired.

In such a configuration, label data is displayed on the display device if a site in which any figure is contained is selected so as to be enclosed or the line segments are drawn if any figure is not contained.

### 12. Twelfth Embodiment

A twelfth embodiment will be described. In the twelfth embodiment, when label image data is transmitted from the terminal device 10, information the terminal device 10 retains may be transmitted.

For instance, various types of information may be stored in the terminal device 10. As the information the terminal device 10 retains, for instance, various types of information including configuration information such as IP address and identity specific to the terminal device and user information such as login name (user name) and user name inputted by handwriting may be stored. The configuration information and the user information will be collectively referred to as environmental information for the terminal device 10 and will be described below.

The environmental information stored in the terminal device 10 may be transmitted to the display device 20 in step S116 in the first embodiment.

Herein, the environmental information may be information stored in advance or information set and stored by the user. The environmental information may also be information set as factory default such as terminal-specific information (production identifying information, MAC address, and the like of the terminal).

Other than login information, there may be user information (user name) bound to figures inputted by handwriting. The user information may be login information for the terminal or information bound to an input device (a touch pen or the like, for instance).

Transmission of such environmental information to the display device 20 makes it possible to change such attributes as color, size, and transmittance of a label in step S152 based on information, such as the environmental information, the terminal device 10 retains.

### 13. Thirteenth Embodiment

A thirteenth embodiment will be described. In the thirteenth embodiment, an appearance on the display device 20 may be changed based on attribute information, the environmental information, and/or the like transmitted with the label image data in the twelfth embodiment.

In the display device 20, specifically, display may be selected or the environmental information may be displayed (the user name may be displayed together with the label data, for instance) based on the attribute. For instance, the user name may be displayed together with the label data or the IP address, machine name, or the like of the terminal that has been transmitted may be displayed.

Switching of validity/invalidity of the attributes and switching of display/nondisplay of the environmental information can be carried out in the display device 20.

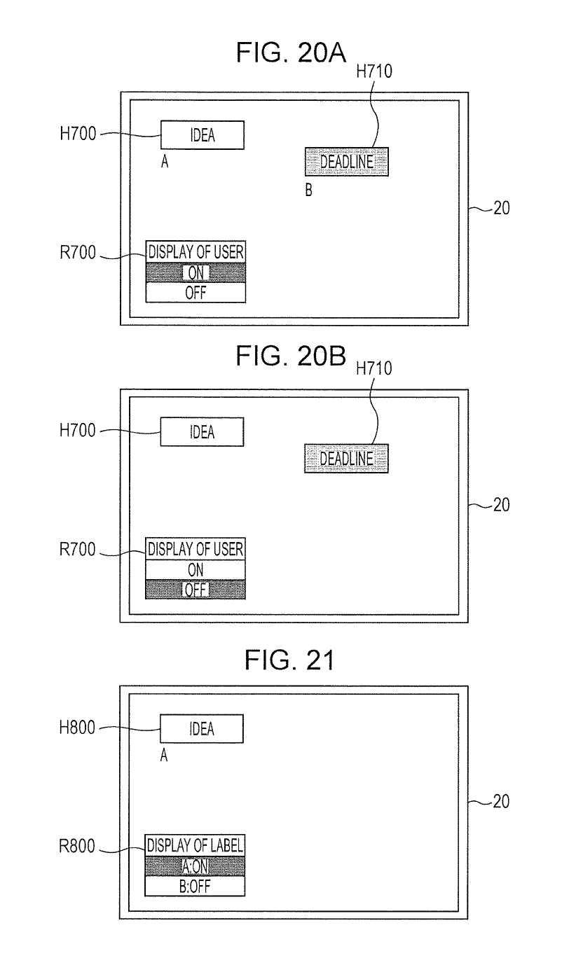

An example of an operation in the embodiment is illustrated in FIGS. 20A and 20B. FIG. 20A is a diagram illustrating the display device 20 in which the environmental information has been turned “ON”. Display of user has been set “ON” by an area R700, for instance.

Accordingly, a user name “A” is displayed adjacent to label data H700. Besides, a user name “B” is displayed adjacent to label data H710.

In FIG. 20B, the display of user has been set “OFF” by a selecting operation on the area R700. In FIG. 20B, any user name is not displayed adjacent to the label data H700 and the label data H710.

According to the embodiment, the display/nondisplay of the environmental information thus can be effected on the display device 20. The switching of the display/nondisplay of the environmental information may be carried out on the terminal device 10. The display/nondisplay may be switched as general setting or may be switched for each label data, for instance. The display/nondisplay may be switched in accordance with the shape of the enclosed area.

### 14. Fourteenth Embodiment

A fourteenth embodiment will be described. In the fourteenth embodiment, the display/nondisplay of label data may be switched with use of the environmental information or the attributes.

For instance, attributes or the environmental information are stored for each label data. Therefore, label data to be displayed can collectively be selected so as to be displayed or so as not to be displayed by the user.

An example of an operation in the embodiment is illustrated in FIG. 21. In FIG. 21, label data to be displayed is selected in an enclosed area R800.

Specifically, selection has been made so that the label data for a user A may be displayed and so that the label data for a user B may not be displayed.

In this example, compared with FIG. 20A, for instance, label data H800 for which the user A is stored as the environmental information is displayed and label data for which the user B is stored as the environmental information is not displayed.

Though the above embodiment has been described with use of the environmental information as an example, the display/nondisplay may be switched with designation of an attribute, such as color and shape, of the label data. The switching of the display/nondisplay may be carried out from the terminal device 10.

Further, a plurality of items of the environmental information and/or the attributes may be combined. For instance, the display/nondisplay may be switched with use of combined conditions such as label data for Mr. A and of high importance and label data for Ms. B and in red.

### 15. Fifteenth Embodiment

A fifteenth embodiment will be described. Hereinabove, the embodiments in which communication between the terminal device 10 and the display device 20 is performed have been described. Hereinbelow, by contrast, an embodiment in which processing is carried out by the terminal device 10 alone or the display device 20 alone will be described.

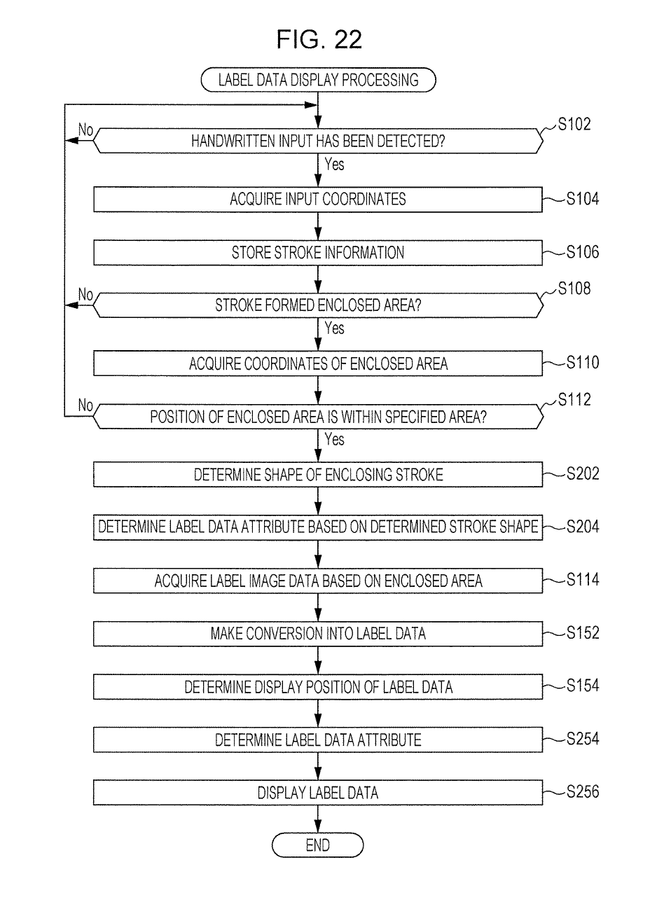

FIG. 22 is processing flow illustrating processing that is carried out in the terminal device 10 or the display device 20. The processing is intended for attaining the operation of the second embodiment by only either of the devices. The data in the storage unit 150b illustrated in FIG. 7 may be stored in the device that carries out the processing of FIG. 22.

The same processing as that of the processing flow illustrated in FIG. 9 is provided with the same reference characters and description thereon is omitted. In FIG. 9, the terminal device 10 acquires (recognizes) the label data (label image data and label data attribute) and the display device 20 displays the label data. The processing of FIG. 22, however, is attained by one device.

That is, an attribute of label data is determined based on a shape of an enclosing stroke inputted by handwriting for displayed figures (step S102; Yes→S104→S106→S108; Yes→S110→S112; Yes→S202→S204). Subsequently, label image data is acquired based on an enclosed area (step S114).

The acquired label image data is converted into the label data (step S152) and a display position of the label data is determined (step S154). The label data attribute is determined (step S254) and the label data is then displayed (step S256).

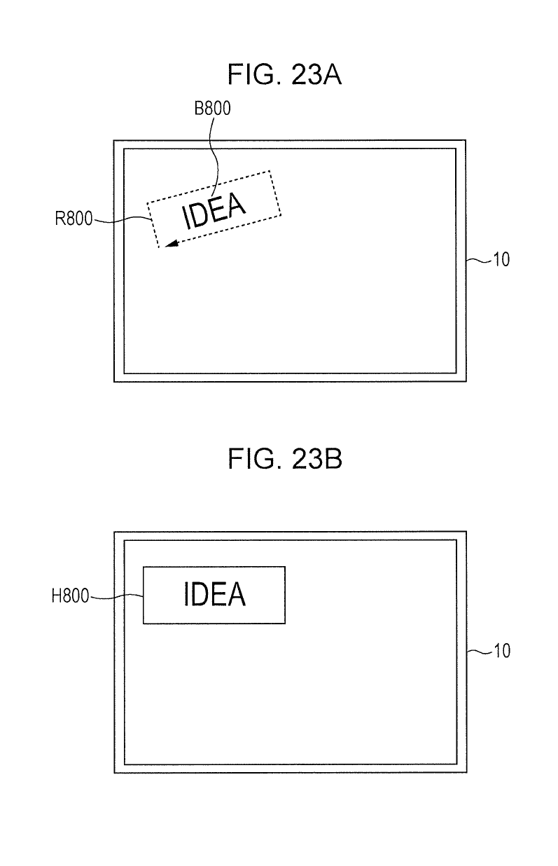

In this step, the label data may be displayed in substitution for an originally selected figure or may additionally be displayed (in another area, for instance). FIGS. 23A and 23B illustrate an example of a screen in the embodiment implemented for the terminal device 10, for instance.

As illustrated in FIG. 23A, a handwritten character string B800 is selected by an enclosed area R800. As illustrated in FIG. 23B, label data H800 is then displayed in substitution for the handwritten character string B800.

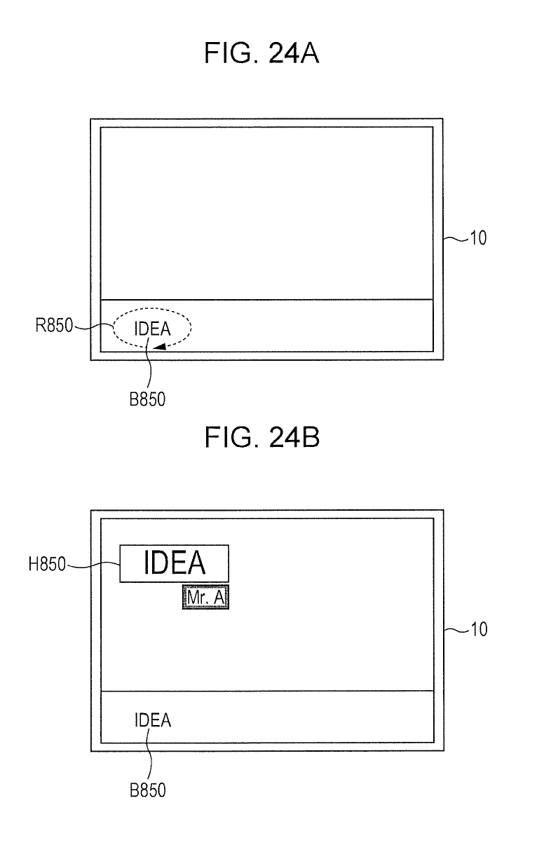

FIG. 24A illustrates a state in which a handwritten character input area and a figure display area (label data display area) are separately present. A handwritten character string B850 is inputted into and displayed on the handwritten character input area on a lower part of the display screen, for instance.

Upon selection of the handwritten character string B850 by an enclosed area R850, label data H850 is displayed. Then the label data H850 is displayed in addition to the handwritten character string B850. In the label data H850 in FIG. 24B, “Mr. A” can be displayed as a name of an inputter (owner), for instance, as described for the above embodiments.

According to the embodiment, the processing similar to above thus can be carried out even by the one device. Though the embodiment has been described with substitution for the flow of the second embodiment, it is a matter of course that label image data and a label data attribute can be determined in the other embodiments and that the display can be carried out based on the label image data and the label data attribute in the embodiments.

Though the embodiment has been described assuming conversion into the label data, for convenience, it is a matter of course that the display may directly be carried out based on the label image data and the attribute of the label data, for instance.

### 16. Sixteenth Embodiment

A sixteenth embodiment will be described. The embodiment in which temporary storage as label data is carried out in addition to the fifteenth embodiment will be described.

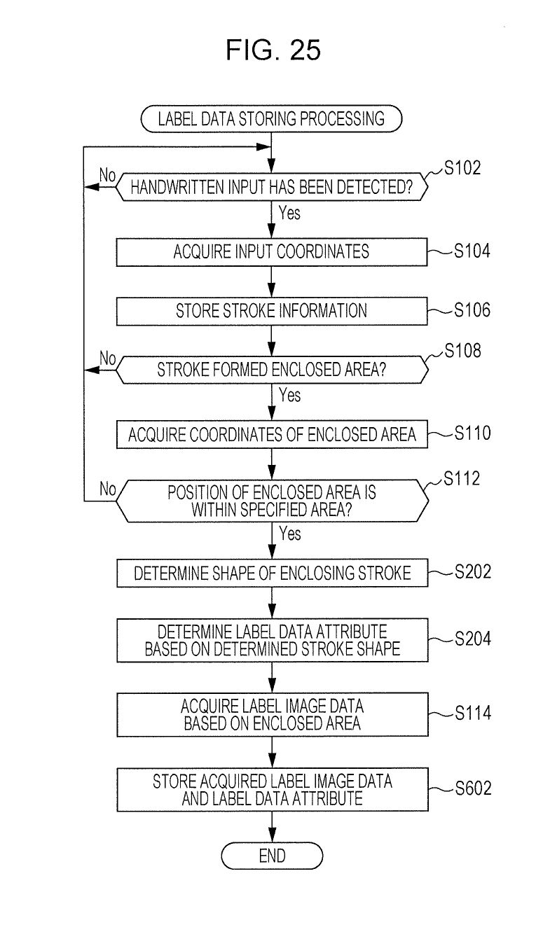

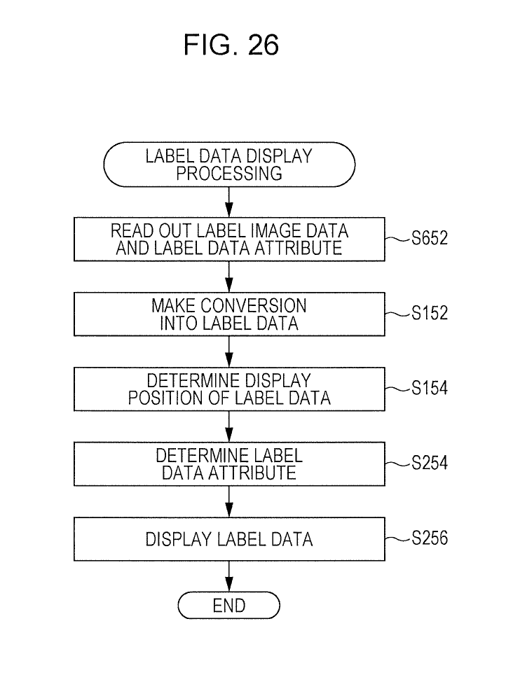

FIGS. 25 and 26 each represent processing flow that illustrates processing that is carried out in the terminal device 10 or the display device 20. The processing is intended for attaining the operation of the second embodiment by only either of the devices. The data in the storage unit 150b illustrated in FIG. 7 may be stored in the device that carries out the processing of FIGS. 25 and 26.

The same processing as that of the processing flow illustrated in FIG. 9 is provided with the same reference characters and description thereon is omitted. In FIG. 9, the terminal device 10 acquires (recognizes) the label data (label image data and label data attribute) and the display device 20 displays the label data. The processing of FIG. 25 and the processing of FIG. 26, however, are attained by one device.

When the processing of FIG. 25 is carried out, label image data and label data attribute are acquired (steps S102 to S114) and the label image data and the label data attribute are stored (step S602), based on an operation by a user.

When the processing of FIG. 26 is carried out, the label image data and the label data attribute stored in step S602 are read out (step S652) and are converted into and displayed as label data (steps S152 to S256).

According to the embodiment, the processing similar to above thus can be carried out even by the one device. Though the embodiment has been described with substitution for the flow of the second embodiment, it is a matter of course that the label image data and the label data attribute can be stored in the terminal device in the other embodiments and that the display can be carried out based on the stored label image data and the stored label data attribute in the embodiments.

The temporary storage of the label data may enable exchange of the label data among different programs and processes. In addition, designation of an external storage device (such as a USB memory) as storage of the label data may enable display on another device that is not directly connected.

### 17. Seventeenth Embodiment

A seventeenth embodiment will be described. The seventeenth embodiment in which timing of transmission of the label data is additionally different in the embodiments described above will be described.

In the embodiments described above (the first embodiment, for instance), the operation of enclosing a figure triggers off the transmission of the label data. The figure, however, may be specified by continuation of an inactive state for a given period of time after entry and the specified figure may be transmitted as the label data.

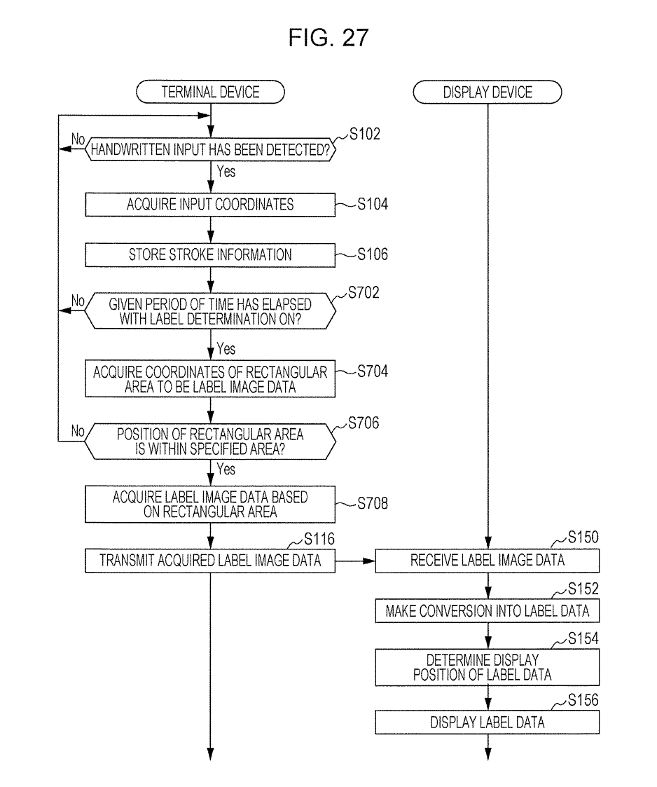

In this case, an area into which data inputted after last timing of the continuation of the inactive state for the given period of time is fitted may be clipped as a rectangular area and may be transmitted as the label data. Processing in the embodiment will be described with use of FIG. 27. In FIG. 27, substitution is made for the processing flow of FIG. 5. Therefore, the same processing as that of FIG. 5 is provided with the same reference characters and description thereon is omitted.

It is determined whether the given period of time has elapsed or not since storage of the stroke information (step S702). If the given period of time has elapsed, coordinates of the rectangular area that are to be the label image data are acquired (step S704). If a position of the rectangular area is within a specified area (step S706; Yes), the label image data is acquired based on the rectangular area (step S708).

In the example of FIG. 6, for instance, the inactive state may be made to continue for the given period of time after handwriting of the characters “IDEA” and the rectangular area may consequently be clipped so that a part where the characters “IDEA” are written may be fitted into the rectangular area. In clipping of the rectangular area, the rectangular area into which the handwriting is fitted may be clipped or angles of the rectangular area to be clipped may be subjected to adjustment or the like in consideration of an inclination of the handwritten characters. The data equivalent to the rectangle R100 may be generated by the adjustment of the rectangular area.

Description will be given on label determination ON in step S702. It is desirable to make a distinction between ordinary handwritten input and input of the label data and thus such an operation as a change in input mode may be carried out between the ordinary handwritten input and the input of the label data. The label determination is turned ON in cases of the input mode for the label data being “ON”, a handwritten input after selection of pen mode for the input of the label data, or the like. In case where the label determination is ON, the label image data is acquired.

Specifically, a mode (handwritten input mode) for the ordinary handwritten input and a mode (label data input mode) for handwritten input that can be converted into the label data can be selected. Upon selection of the label data input mode and performance of a handwritten input, the processing of the embodiment is carried out. That is, a conversion into the label data (label image data) is made after a lapse of the specified period of time after the handwritten input. A handwritten input performed in the handwritten input mode that is an ordinary input mode is not converted into the label data (label image data) even after the lapse of the specified period of time. The conversion into the label data is made on condition that the label data input mode has been selected as a specified input mode, for instance.

As described for the first embodiment, for instance, the conversion into the label data (label image data) is made when an inputted figure is enclosed (when the enclosed area is formed by a stroke). In the embodiment as well, an operation of enclosing an inputted figure may be made an operation that causes the conversion into the label data before the lapse of the specified period of time.

The label determination may be turned ON by switching to the mode for the input of the label data or by a mode ON switch or the like. It may be determined that the label determination is ON, in cases where a specified operation (such as an operation with a button on a pen being pressed, a handwritten input with a touch by one hand, and an operation using two fingers) is carried out.

Depending on a system, all of input in a specified area may be determined as the label image data or all of handwritten input may be converted into the label image data.

Though the above embodiment has been described with use of the “rectangular area”, the area has only to be an enclosed area (closed area) and may have various shapes such as circular, elliptical, triangular, and trapezoidal shapes. The user may set a shape of the area.

### 18. Modifications

The disclosure is not limited to the embodiments described above but may be modified in various manners. That is, embodiments obtained by combination of technical devices appropriately modified within a scope not departing from the purport of the disclosure are included in the technical scope of the disclosure.

Though the embodiments in which the label image data is transmitted from the terminal device 10 to the display device 20 have been described above, a terminal to which the data is transmitted may be other than the display device. For instance, the data may be transmitted to an image forming device so as to be printed or saved as a PDF file.

Furthermore, the label image data may be transmitted by e-mail, transmitted (uploaded) to SNS, or saved in cloud. Moreover, selected label data may be saved in a recording medium.

Though the terminal device and the display device as the image display devices have been described for the embodiments, the devices may be configured as one device. It is a matter of course that the terminal device and the display device may be connected via cloud.

In use of cloud, the label image data may be transmitted from the terminal device through a cloud server to the display device. A part of the processing in the terminal device and the display device may be carried out by the cloud server.

The above functions may each be configured as programs or as hardware. In cases where the functions are implemented as programs, the programs recorded in a recording medium may be read out from the recording medium in order to be executed or the programs saved in a network may be downloaded in order to be executed.

Though the description on the above embodiments has been given with use of the touch panel as the touch detection unit and with use of the touch operation (tapping operation) as an example, the operation may be carried out by a click operation or the like on an external input device such as a mouse.

Though the examples in which the display device includes the display unit and the operational input unit have been described for the above embodiments, it is a matter of course that another scheme may be used in order that the disclosure disclosed in the embodiments may be implemented. For instance, a projector may be used as the display unit 210 and a person detecting sensor may be used as the operational input unit 220. A display system may be implemented by connection of a computer for control to the operational input unit 220 and the display unit 210.

Though some portions of the above embodiments have been described separately for convenience, it is a matter of course that the portions may be carried out in combination within a technically feasible scope. For instance, operations of the seventeenth embodiment may be carried out in combination with other embodiments.

Thus the embodiments described herein may be carried out in combination as long as any conflict is not caused therein.

In the embodiments, as described above, an area is specified by being selected. Herein, methods of specifying an area include various methods such as input and determination, other than the selection.

The programs operating in the devices in the embodiments are programs that control the CPUs and the like (programs that make computers function) so as to implement the functions of the embodiments described above. The information that is handled in the devices is temporarily accumulated in a temporary storage (such as RAM) during processing thereof, thereafter stored in a storage such as ROM, HDD, and SSD, and read out for modification and/or writing by the CPU as appropriate.

For distribution to market, the programs may be stored in portable recording media to be distributed and/or may be transferred to server computers connected through networks such as the Internet. It is a matter of course that storages for the server computers are encompassed by the disclosure.

The present disclosure contains subject matter related to that disclosed in Japanese Priority Patent Application JP 2016-148786 filed in the Japan Patent Office on Jul. 28, 2016 and Japanese Priority Patent Application JP 2017-137881 filed in the Japan Patent Office on Jul. 14, 2017, the entire contents of which are hereby incorporated by reference.

What is claimed is:

1. An image display device comprising:
a figure input unit through which figures including characters are inputted;
an image display unit that displays an image in which the one or more inputted figures are placed;
an area specification unit through which a partial area in the displayed image is specified;
a figure acquisition unit that acquires figures contained in the specified area;
an attribute determination unit that determines an attribute of the acquired figures which is used when the figures are displayed; and
a figure display unit that displays the acquired figures based on the determined attribute of the figures.

2. An image display device capable of communicating with another image display device capable of displaying an image in which figures including characters are placed, the image display device comprising:
a figure input unit through which figures are inputted;
an image display unit that displays an image in which the one or more inputted figures are placed;
an area specification unit through which a partial area in the displayed image is specified;
a figure acquisition unit that acquires figures contained in the specified area;
an attribute determination unit that determines an attribute of the acquired figures which is used when the another image display device displays the figures; and
a figure transmission unit that transmits the acquired figures and the attribute of the figures for display on the another image display device.

3. The image display device according to claim 1, further comprising:
an area recognition unit that recognizes an attribute of the area,
wherein the attribute determination unit determines the attribute of the figures based on the attribute of the area.

4. The image display device according to claim 1,
wherein the area specification unit specifies the area with the partial area in the displayed image enclosed.

5. The image display device according to claim 3,
wherein the attribute of the area is set based on at least any of information on a shape of the area, information as to whether a stroke was drawn clockwise or counterclockwise when an enclosed area was drawn, information on a number of fingers or pens for drawing of the stroke, and information as to whether an enclosed area was inputted with another operation or not.

6. The image display device according to claim 3,
wherein the attribute of the area is set based on at least any of information on a user who operates the image display device, information inputted from an input unit of the image display device, and information the image display device retains.

7. The image display device according to claim 1,
wherein the figure input unit can perform input operations with switching between an ordinary input mode and a specified input mode, and
wherein the area specification unit specifies the area so as to contain figures inputted in the specified input mode.

8. The image display device according to claim 7,
wherein the area specification unit specifies the area after a lapse of a specified period of time after an input operation.

9. The image display device according to claim 1,
wherein the attribute of the figures is information on at least any of size, color, shape, importance, and owner.

10. An image display system comprising:
a first image display device and a second image display device that are each capable of displaying an image in which figures including characters are placed,
wherein the first image display device includes
a figure input unit through which figures are inputted,
an image display unit that displays an image in which the one or more inputted figures are placed,
an area specification unit through which a partial area in the displayed image is specified,
a figure acquisition unit that acquires figures contained in the specified area,
an attribute determination unit that determines an attribute of the acquired figures which is used when the second image display device displays the figures, and
a figure transmission unit that transmits the acquired figures and the attribute of the figures to the second image display device, and
wherein the second image display device displays the figures received from the first image display device.

11. The image display system according to claim 10,
wherein the second image display device displays the figures based on the attribute of the figures received from the first image display device.

12. The image display system according to claim 10,
wherein the figure transmission unit additionally transmits environmental information, and
wherein the second image display device additionally displays the environmental information when displaying the figures received from the first image display device.
